(19) United States
(12) Patent Application Publication
(10) Pub. No.: US 2010/0185630 A1
(43) Pub. Date: Jul. 22, 2010

(54) MORPHING SOCIAL NETWORKS BASED ON USER CONTEXT

(75) Inventors: Lili Cheng, Bellevue, WA (US); Scott J. Counts, Seattle, WA (US); Danyel Aharon Fisher, Seattle, WA (US); Dragos A. Manolescu, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/346,419

(22) Filed: Dec. 30, 2008

(51) Int. Cl. G06F 17/30

(52) U.S. Cl. 707/756; 707/E17.005

(57) ABSTRACT

Providing for adaptive networking based on user context is disclosed herein. By way of example, networking usage patterns, preferences and disposition toward a network or network interface can be monitored and analyzed to determine the user context. In some aspects, the usage context can be further modified based on language processing of content of messages sent or received by the user. Once determined, user context can be employed to adapt a composition of a network, including user nodes of the network as well as interface tools for accessing the network, based on the user context. As user use patterns change, the network can be further adapted to account for changes in user context over time, or other suitable user categorizations. Accordingly, the subject disclosure provides a powerful tool for breaking user-software paradigms requiring the user to adapt to the network and network tools.

### BACKGROUND

Integrated network communications have provided significant advances in social and enterprise activities. On the enterprise side, efficiencies with which individuals can share information, perform tasks, disseminate instructions, search for knowledge-based resources, expose data to users, or share user concerns have greatly increased by advantages provided by inter-personal networks. In regard to social networks, user inter-connectivity and inter-relatedness have been increased as social networking websites, such as Facebook.com, Twitter.com, LinkedIn.com, and so on, have enabled users to share personal information, media files, media applications, pictures, videos, audio, and so on, over the Internet.

In addition to the foregoing, E-mail and other electronic messaging systems have enabled a technical revolution in business and personal communications, and have provided a platform for integrated social and organizational networking. In recent years, use of electronic messaging, such as e-mail, short messaging, text messaging, blogging, electronic forums, and so on, has increased exponentially due to the inexpensive and near instantaneous communication platform that electronic messaging provides. Such platforms have rapidly decreased the time required to share and disseminate information, whether for a large, multi-national organization, a network of friends or family members, or remotely located small business partners.

To provide convenience and additional inter-connectivity, wireless networks have become extremely popular as well. Where prior to such networks, fixed processing devices, such as desktop computers, mainframe terminals, and the like, were required for electronic communication and networking, now wireless communications have enabled smaller mobile processing devices, such as laptops or personal digital assistants (PDAs) to act as user gateways to electronic networks. Such devices allow for a degree of user mobility in addition to the communication benefits provided by fixed processing devices. Furthermore, mobile communication networks enable true user mobility via a small hand-held device that can wirelessly couple with remote wireless access points. Thus, even while running or jogging in a park, driving an automobile, or flying in an airplane in some circumstances, users can connect to an electronic network.

As communication devices become more prevalent and drop in price, greater numbers of users can afford to join in the electronic communication revolution. In recent years, a substantial portion of the global population has been able to afford at least one electronic networking device, and many are able to afford multiple such devices. Accordingly, the electronic communication revolution has truly become a global phenomenon, enabling near real-time personal and business interaction throughout the globe in a manner heretofore unknown.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure provides for morphing communication networks and interfaces to such networks based on user context with respect to a network. User usage patterns and preferences can be monitored at a device or interface employed in accessing a network, and analyzed to determine the user context. In some aspects, content of messages exchanged via a network also can be analyzed, optionally as a function of the device or interface employed in accessing the network, to determine the user context. According to other aspects, a user's disposition toward a network, device or interface can be identified and employed in determining the context. Such context can comprise any suitable categorization of user-device relationship. Examples can include, at a high level, business use, personal use, time-based use (e.g., morning user, evening user, daily user, weekly user, etc.), expertise, etc., and at a finer level, e-mail user, instant message (IM) user, message board user, mobile user, persistent or infrequent user, voice user or a combination thereof.

Based on a determined user context, network composition can be adapted to meet a particular user. In some aspects, an adaptable network composition can comprise dynamic user connectivity for the network, such as links between user ‘nodes’ in a social network. In other aspects, adaptable network composition can comprise dynamic interface applications employed to access the network. As an example of the former, user connectivity can be modified based on the user context, changing relatedness between one or more users or degree of relatedness (e.g., number of ‘hops’ between one user and another). As an example of the latter aspects, network applications can be updated to highlight or hide features of the application, or to include features of other such applications, or of newly released versions of applications. In other words, a user's relationships with other users, as well as a user's relationship with tools employed in utilizing the network can be adapted to user context.

As network composition is adapted, data can be exposed from the network to describe or summarize changes. Thus, for instance, a user can be notified of a change in user connectivity. The notification can be text or voice based, or graphical, depicting a multi-dimensional display of the new composition and disparities based on the changes. Where interface applications are adapted to user context, application tools can be provided to summarize the changes and provide instructions on use of the adapted applications. Such tools can include help files, tutorial applications, and the like. Accordingly, the subject disclosure provides a powerful mechanism to customize a network to a user's context in relationship with the network, and breaks a typical networking mold that requires a user to adapt to changes in an application, update user connectivity, or re-learn new or modified application features.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 depicts a block diagram of an example system for adapting network composition to a context of a user in accordance with aspects of the subject disclosure.

FIG. 2 depicts a block diagram of a sample system that tracks user usage and physical context to determine a user context pertinent to a network.

FIG. 3 illustrates a block diagram of an example system that identifies changes to network applications based on user context.

FIG. 4 illustrates a block diagram of a sample system that adapts user connectivity based on user context.

FIG. 5 depicts a block diagram of an example system that determines user connectivity in a social or enterprise network.

FIG. 6 depicts a block diagram of an example system that outputs adapted connectivity data to a user device according to particular aspects disclosed herein.

FIG. 7 illustrates a flowchart of a sample methodology for adapting network composition based on user context according to further aspects.

FIG. 8 depicts a flowchart of an example methodology for providing adapted user connectivity based on user context according to other aspects.

FIG. 9 illustrates a flowchart of a sample methodology for providing adapted network applications based on user context according to yet other aspects.

FIG. 10 depicts a block diagram of a sample operating environment suitable to implement processing and data storage for adapting network composition.

FIG. 11 depicts a block diagram of an example remote communication environment providing data exchange between remote server and client devices.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “engine”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component can be localized on one computer and/or distributed between two or more computers. As another example, an interface can include I/O components as well as associated processor, application, and/or API components, and can be as simple as a command line or a more complex Integrated Development Environment (IDE).

Communication networks have become powerful tools for sharing knowledge and experience in social settings as well as business settings. Currently, such networks can provide real-time dissemination of information, at almost any distance around the globe. Networks can be public, like the Internet and World Wide Web, or private, such as personal or business networks requiring authorized access to a limited subset of users. Furthermore, communication networks can employ wireless device access or fixed-line device access, or both. Additionally, sub-networks can exist within a larger network, such as a domain or sub-domain, having particular applications and application features, settings or preferences local to the sub-network. Accordingly, by selectively configuring a sub-network, distinctiveness is achieved, both in displaying information to a user, providing access to the user and in facilitating user control over various user-oriented applications.

Recent applications for communication networks include electronically characterizing human groups and organizations and providing a means of electronic communication between members thereof. Human interactions and relationships, termed social networks, include families, groups of friends, business and investment partners, instant message ‘buddies’, members of for profit and non-profit organizations, and the like. In one characterization of inter-personal relationships, individual persons are represented as nodes of a network, and ties between the nodes are based on various interactions and communications between the persons. Each person, or node, is directly connected to others whom the person has direct interaction with. Such person is indirectly connected with other persons, whom their direct contacts have direct interaction with, and still other persons who their direct contacts have indirect interaction with (through one or more other persons), and so on. Thus, in such a characterization of inter-personal relationships, a social network is analogous to a large web of interconnected person-nodes.

By storing and updating node and connectivity data electronically, for instance in a database that tracks individual persons and their direct and indirect relationships, an underlying web of inter-personal relationships can generate an electronic social network. Such a network can be updated over time to reflect changes in inter-personal relationships, or contexts of such relationships. Furthermore, contextual data can be associated with user nodes or links between nodes to characterize aspects of persons represented by the nodes, and inter-personal relationships represented by the links. A server coupled with the database can update stored information to reflect changes in inter-personal relationships, and output node, link or context data (e.g., in the form of text descriptors such as tags, metadata, pop-ups, mouse-over tool tips, and so on, or media such as photographs, video files, audio files, or combinations thereof) for consumption by a network user.

Some electronic social networks are maintained on Internet web sites, including sites such as Facebook®, Twitter™, LinkedIn.com®, or the like. In addition, many corporations include electronic social networks maintained on private intranets, and some private individuals and businesses also maintain electronic social networks on various public and private networks. Electronic social networks that enable individuals to post or share data and media (e.g., photographs, videos, audio recordings, text, blogs, and the like) pertaining to their personal or business interests, hobbies, areas of expertise, research, political views, business ventures, investment portfolios or interests, and so on. In addition, an underlying communication network (e.g., Internet, intranet, mobile communication network, private network) supporting an electronic social network can facilitate electronic communication and data exchange between user nodes of such a social network, in the form of instant message (IM), short message service (SMS), e-mail, voice communication (e.g., voice over Internet Protocol [VoIP], or circuit-switched voice), or other forms of electronic communication. To interact with other network users or with network components supporting the social network, a communication device, such as a computer, mobile phone, laptop, personal digital assistant (PDA), or like electronic device is employed by a network user. Thus, the electronic device provides an interface to the electronic social network and consequently with other network users.

One use for electronic social networks in enterprise is to connect individuals having various experience and expertise on projects and tasks of the organization. Thus, employees can identify individuals having experience in a particular field or on a particular task. Data can be exchanged between such users to effect or guide performance of the task. In addition, enterprise management can disseminate instructions throughout an enterprise, or to selected divisions, workgroups or members thereof, via the electronic social network. Moreover, users can spread information virally, from user to user, employing e-mail, IM or other mass electronic communication mechanisms. The electronic social network therefore can serve as a useful tool in conducting enterprise activities and accomplishing tasks, by disseminating instructions or coupling users of the enterprise.

Although electronic social networks can be beneficial in providing and sharing information among users, the networks have had limited intelligence implemented to increase user efficiency. Users typically upload a very rich set of personal, professional and social information pertaining to them, as well as characterizing context for such information. Leveraging such information can be very helpful in solving tasks, identifying ideal members for a workgroup, finding an expert on a particular issue, obtaining synergistic benefits from collaborative analysis, and the like. Unfortunately, however, the networks themselves do very little in the way of data mining to solve user problems, or to facilitate new approaches to old methods. As another example, the networks have no capability to modify composition or a view of an electronic social network, (e.g., a subset of nodes and node-links of the social network, modified with respect to the underlying social network composition) to optimize user interaction and leverage user experience.

In addition to the foregoing, the communication networks that support and facilitate electronic social networks can be very diverse in terms of interface applications, systems or devices providing user access to the network, or in communications platforms employed by the network to implement electronic user interaction. Because of this diversity, some level of expertise is typically required to configure user applications, systems and devices to conform to individual user desires. Furthermore, some configuration may require authorized access (e.g., by a network administrator) to minimize risk of configuration errors, un-wanted changes to user web-space, loss/corruption of data, and the like. Thus, user customization of a network or an interface to the network can be limited by a user's experience level and network access permissions.

Additionally, some users have preferences for particular interface applications (e.g., a web browser) over other applications (e.g., a messaging application such as IM). Moreover, users can exhibit a varying degree of interest in adapting their use experience to utilize new features of an application, or to utilize new applications. As an example, some users prefer e-mail, and will forego almost all other applications and the rich functionality provided by such applications. Thus, for instance, the e-mail user might not be interested in using a social network, or enterprise network to share information, obtain instructions, or learn about colleagues or friends of colleagues, except what is available through the e-mail program. Accordingly, the rich interpersonal and contextual information available from the social network might not be accessible to such a user, or accessible only via the constraints of their ‘trusty’ e-mail application. As another example, some users prefer a particular version of an application, interface or program and resist spending time to learn or re-learn new applications and the functionality they provide. Other users might have a propensity to utilize new applications or versions thereof, but only insofar as the new application is familiar to their prior experience and personal knowledge. On the other end of the spectrum, some users might be eager to learn new applications and search out new features, and consequently feel overly limited by typical user configurable interfaces. Accordingly, a very real problem for modern program development is finding a way to roll out new application features without upsetting static users, while providing feature richness sought by dynamic users.

The subject disclosure provides for adaptive representations of social networks that can be updated automatically based on determined user context. User usage of network interface applications, such as a web browser, webpage, messaging interface (e.g., e-mail, IM, short message service (SMS), voice-to-text (V-T) or text-to-voice (T-V) application, or the like), etc., can be monitored to obtain user preferences and user habits. Data and statistics pertinent to the usage can provide a usage context for the preferences and habits. The usage context can be employed in adapting network features and customizable systems, nodes, links or inter-relationships of an electronic social network, or features, functions or structure of interfaces to the network, based on individual user usage context. Thus, as one example, a view or representation of a social network can be adapted to optimize user contexts, expertise or disposition, with respect to user activity. For instance, user expertise and experience pertaining to a task can be leveraged to modify the representation of the social network—identifying users able to drive the task, arranging them in a manner to optimize sharing of experience or knowledge, and providing contextual information descriptive of the representation to facilitate user understanding of the machine-generated network composition—to increase effectiveness and efficiency of users working on the task.

According to other aspects, usage context as well as messaging content analysis can be employed to determine user disposition toward a network or interface thereto. Based on the context or disposition, features of particular networks or applications can be blended into other networks/applications to increase feature richness on a preferred platform(s). Thus, for instance, a user who has a favorable disposition to an e-mail application, yet often employs a browser application to obtain information pertaining to other users of a network, can be determined to benefit from social networking features for sharing inter-personal information. The e-mail application can be integrated with a visualization graph of user-connectivity determined from frequent or important e-mail messaging partners (or, in some circumstances, of infrequent messaging partners, to expose information to the user which is unlikely to have been previously sought). The degree of integration can depend on a determined expertise of the user in employing the e-mail program and the web browser. Accordingly, adaptation of the e-mail program for a user who uses only basic e-mail functionality can be slight, whereas adaptation of the program for a user who employs advanced functionality can be more extensive. Thus, by adapting network composition, applications or interfaces to user context, disposition and expertise, a powerful tool can be provided to users based on individual comfort level and experience.

It should be appreciated that, as described herein, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). The aforementioned carrier wave, in conjunction with transmission or reception hardware and/or software, can also provide control of a computer to implement the disclosed subject matter. Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the amended claims, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

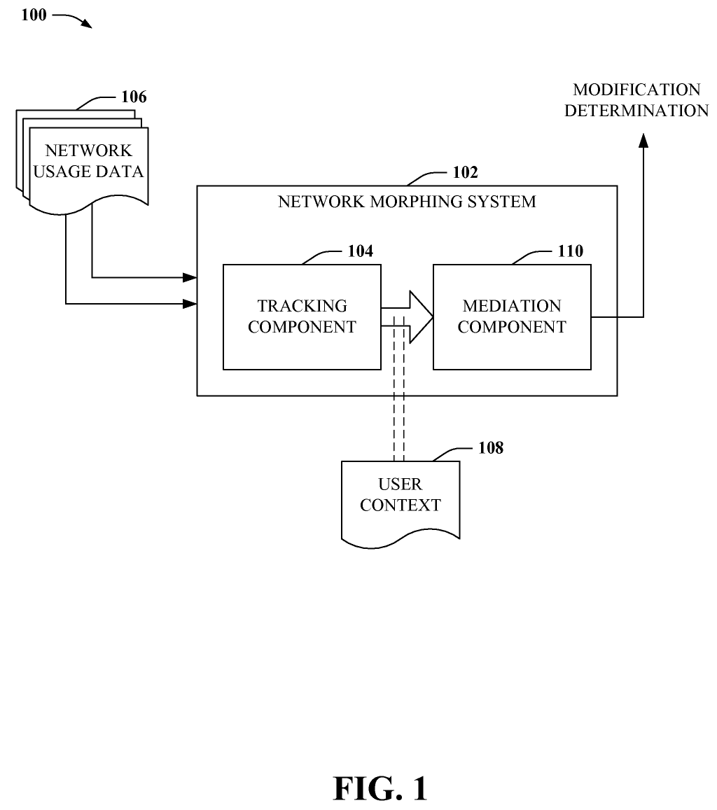

Referring now to the figures, FIG. 1 depicts a block diagram of an example system 100 for providing adaptive networking in accordance with aspects of the subject disclosure. Adaptive networking can comprise determining user context with respect to a network or an interface application for the network, and updating features, user nodes, or user categorization based on the user context. Functionality employed by various types of networks (e.g., social network, enterprise network, public network, etc.) and interface applications (e.g., e-mail, IM, web browser, web page, SMS, mobile device application, and so forth) can be integrated into a preferred application, or employed in creating a custom application for the user. Accordingly, system 100 provides for a new paradigm in user-software dynamics, enabling the software to adapt to context, disposition and preferences of a user.

System 100 comprises a network morphing system 102 that can adapt network nodes, user connectivity, application functionality or user categorization (e.g., user workgroups, ‘friend’ groups, buddy lists, and so on), associated with a network and/or electronic social network, based on determined context of a user. The network morphing system 102 can comprise a tracking component 104 that determines a user usage context 108 with respect to a network. The usage context can be obtained from network usage data 106 pertaining to the user. In addition, the usage context can be updated over time based on changes in user habits and disposition toward the network, users of the network, or tools employed in accessing the network or communicating with other users.

At a high level, the user context 108 can be determined by tracking component 104 from a wide variety of user-device interactions, user-user interactions employing a network or communication device, user preferences, direct or indirect user input, manual configurations, and the like as described herein. In some aspects, user-device interactions can comprise user habits or disposition toward a particular network or interface application pertaining to the network. For instance, tracking component 104 can monitor user messaging habits, determine preferred applications (e.g., based on frequency or degree of use), common inter-user interactions, or categories of users (e.g., based on expertise, work groups, business divisions such as marketing, engineering, finance, maintenance, and the like, social groups such as buddy lists, and so forth).

Examples of messaging habits can include inbox maintenance, such as propensity to open received messages, forward received messages, delete messages, reply to messages, file messages in sub-folders, etc., numbers of other users copied to messages or removed from message chains, speed with which received messages are acted upon (e.g., opened, replied to, forwarded, deleted, etc.), frequencies of such responses, or a combination thereof or of the like. Other indicators of user habit can comprise a number of applications concurrently executed or utilized by the user, public networks or network interfaces employed by the user (e.g., Facebook.com, Twitter.com, LinkedIn.com), whether the user subscribes to or aggregates RSS feeds (e.g., really simple syndication [RSS 2.0], RDF site summary [RSS 1.0 AND 0.90], rich site summary [RSS 0.91]), devices employed by the user to execute such applications, number and variety of such devices, number or type of application features employed by the user, frequency of employing such features, and so on. In at least one aspect, the usage information can be utilized to categorize (e.g., user expertise category) and rank the user with respect to other users of the network.

To facilitate determining user context, users can be categorized based on monitored usage habits. Thus, for instance, a user can be categorized as an expert user, beginning user, moderate user, and so forth, relative to network interface devices (e.g., laptop, desktop, mobile phone), applications or systems, based on number of application features employed, frequency of employing such features, degree of user interface customization, frequency with which a user searches for application settings and implements such settings, and the like. In addition, groups of expert, beginner, moderate, etc., users can be compiled and included in the usage context 108. Such groups and user categories can form a relationship between users as one basis for determining inter-user connectivity and relatedness.

According to other aspects, use context 108 can comprise physical context information of a user. The physical context can include user location (e.g., determined via global positioning system [GPS] or derivatives thereof, such as global navigation satellite system [GNSS]), time of day, current user activity (e.g., working on a project, having a meal, exercising, talking on a telephone, sleeping, etc.), user appointments on a calendar application, or device employed in accessing a network (e.g., office desktop, home desktop, laptop, mobile phone). Additionally, use context 108 can comprise user profile settings for one or more interface applications, as well as manual input pertaining to user context, indicating a preferred network interface application, preferred network (e.g., social network, corporate network, public network) expertise-level of the user with respect to one or more applications, devices, user-specified interests, personal and professional experience, specified user connectivity, and the like. In at least some aspects of the subject disclosure, the user context 108 can be further based on content of recent messages sent/received/forwarded/opened/replied to by the user. The content can be determined from natural language processing or other language processing algorithms (not depicted). Such content might specify projects the user is working on, individuals the user plans to meet, meetings or social events the user plans to attend or is attending, and so on. Accordingly, user context 108 can be based on a diverse set of data related to a user, determined from various user-device interactions, electronic communications or user input. It should be appreciated that other user context data can be employed in determining the user context 108, although not specifically articulated in the examples provided herein.

Based on network usage data 106 and other contextual data pertaining to the user, tracking component 104 generates a user context 108 for the user, describing the user in one or more categories, such as expert user, business decision-maker, social maven, out of office, away from keyboard/networking device, on vacation, etc. The user context 108 is provided to a mediation component 110. Mediation component 110 can employ the user context 108 and generate a modified network composition for the user based on at least one category of the user context 108. The modified network composition can comprise an updated social connectivity mapping, connecting the user with other network users sharing like interests, projects, expertise, sharing common needs (e.g., identified by content of a message, or manually input by the user), or the like. Alternatively, or in addition, the modified network composition can include instructions or code for modifying one or more interface applications employed by the user to interface to the network (e.g., incorporating social networking functionality and user-connectivity or graphical display of such connectivity into an e-mail program). Thus, based on the modified network composition, a network employed by the user can be adapted to a particular context of the user.

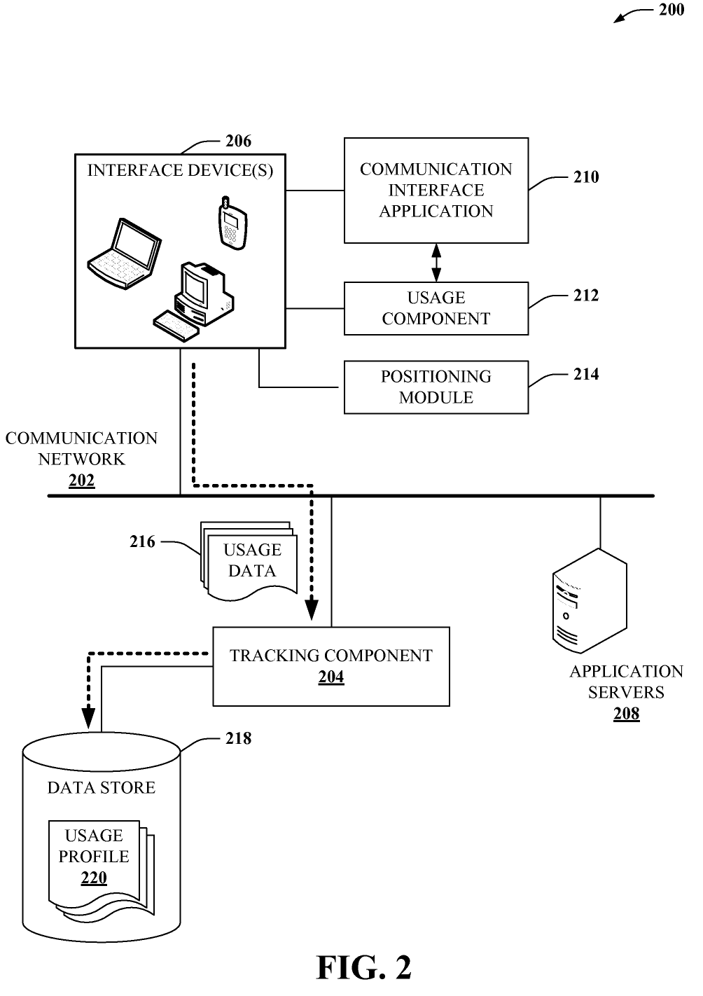

FIG. 2 depicts a block diagram of an example system 200 for collecting usage and connectivity data in determining a user context according to aspects disclosed herein. System 200 can comprise a remote communication interface 202, such as an ad-hoc wired or wireless connection, or a network, such as an office network, public network, private network, mobile network, (e.g., wireless local area network, wired or wireless wide area network, etc.) or the like, or a combination thereof. System 200 can further comprise one or more interface devices 206 with which a user can access the interface 202 and application servers 208 integrated with the interface 202. Furthermore, system 200 can comprise a tracking component 204 that obtains raw usage data 216 pertaining to the user's interactions with the interface 202, to generate a user context for the user, as described herein.

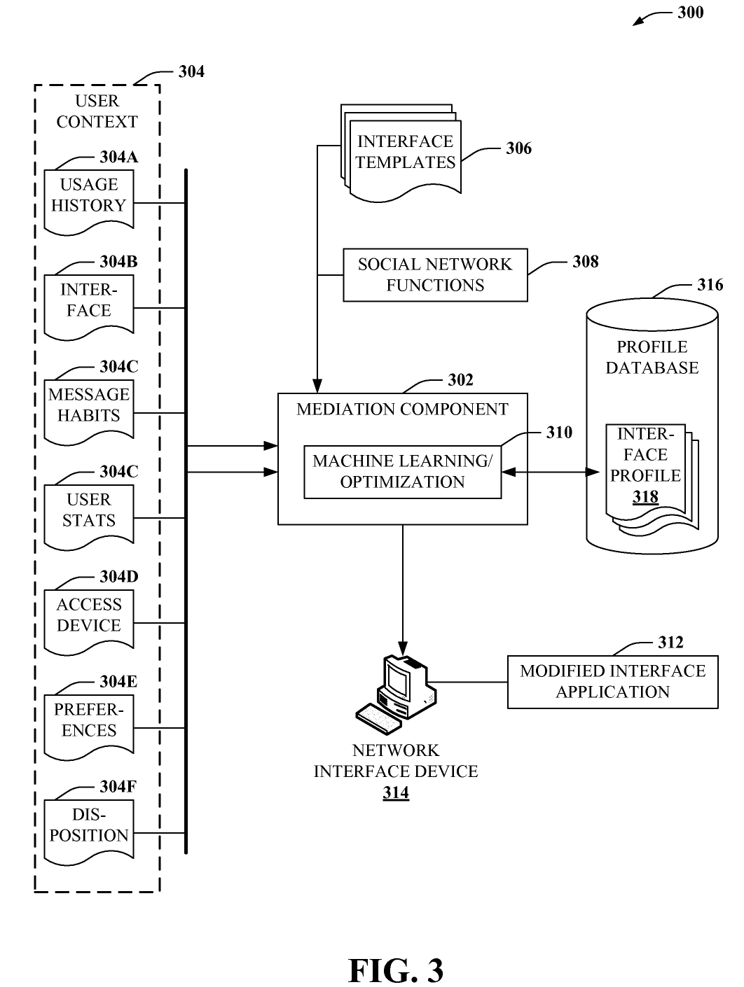

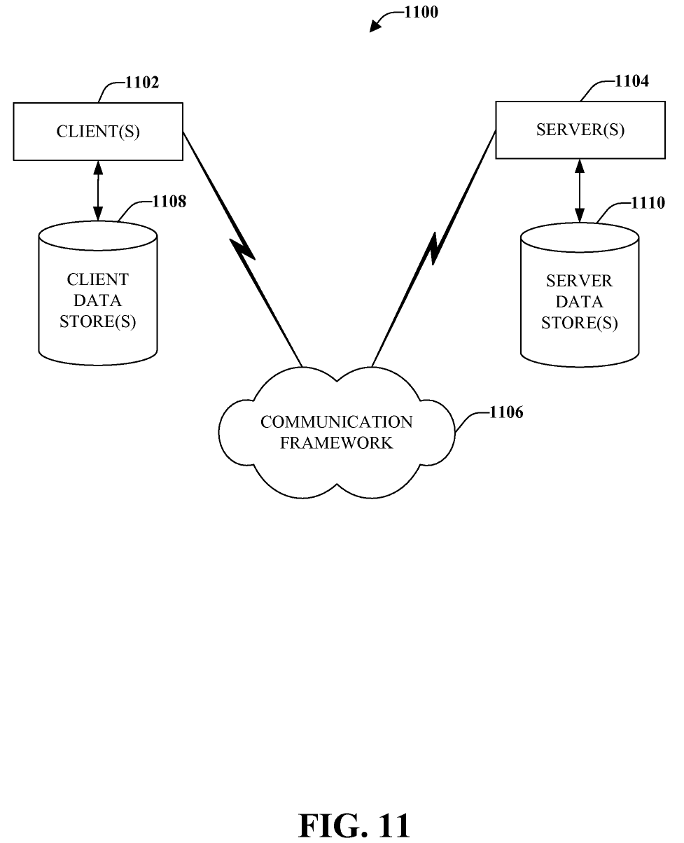

According to some aspects, system 200 can comprise a communication interface application 210 coupled with an interface device(s) 206, providing a software user interface to the physical communication interface 202. In particular aspects, the communication interface application 210 can include a client application associated with the application servers 208, providing remote client-server interaction (e.g., see FIG. 11, infra) for remote communication. Particular examples of the interface application 210 can include a web browser, e-mail application, IM application, web page interface, mobility application, and so on. In at least some aspects, the interface application 210 can include inter-application templates for adapting the application to include functionality of disparate types of applications, as described herein (e.g., see FIG. 3, infra).

System 200 further comprises a usage component 212 that can monitor user interaction with the interface application 210. Such interaction can include monitoring application features employed by a user, error messages output by the application 210 or device(s) 206 based on feature usage, input/output tools and tool preferences, such as typing, T-V or V-T, video display or audio display, pointing device, etc., messaging habits, and so on. Further, the usage component 212 can track frequencies with which the user employs the application or features, frequency of error messages or categories of such messages, frequency of employing the input/output devices, or time periods associated there with. Statistical analysis can be employed to provide average usages, mean usages, and so on, to determine preferred features and applications, as well as user expertise with respect to such features/applications and input/output devices. In at least some aspects, usage component 212 can employ language processing to analyze content of messages sent/received by the user for contextual information. According to still other aspects, system 200 can comprise a positioning module 214 that determines location of the device 206 or user of such device. The positioning module 214 can also monitor calendar, meeting, and like features of application 210 to infer user position and other physical context (e.g., time of day, whether eating or sleeping, in whose company, etc.). Data monitored or inferred by the usage component 212 and positioning module 214 can be written to a usage data file or application 216, submitted by the device to the tracking component 204.

Upon receiving the usage data file/application 216, tracking component can store such file/application 216 in a usage profile 220 at a data store 218. Furthermore, subsequent usage data/applications 216 can be utilized to update the usage profile 220, or alter the profile 220 based on changes in user usage patterns or physical context. The usage profile 220 can be made available to other components in implementing adaptive networking as described herein.

FIG. 3 depicts a block diagram of an example system 300 for adapting social network composition based on context of user network usage according to aspects of the subject disclosure. System 300 can employ diverse information pertaining to the user and user interactions with a network, network interface tools, and other users of the network to determine the user context. Changes in user information can be periodically obtained, or based on some non-periodic or non time-based function, or obtained based on command, or based on a threshold change in user information as determined by a data tracking component (not depicted). Once determined the user context can be employed to adapt nodes of the network to modify data output to the user. Alternatively, or in addition, the user context can be employed to integrate interface functionality of disparate applications or networks. Accordingly, system 300 can create a powerful data sharing tool customized to preferences and habits of the user.

System 300 can comprise a mediation component 302 that obtains user context data 304 defining a context of a user. The context data can comprise usage history information 304A detailing a manner in which a user interacts with a network, or interface applications employed to implement features of the network. The context data can additionally comprise a preferred interface or interfaces 304B for the user, as well as messaging habits 304C pertinent to a messaging application coupled with the network (e.g., e-mail, IM, SMS, etc.). In some aspects, the context data can comprise user statistics and connectivity 304C, including other users of the network that the user messages or receives messages from, forwards messages to, copies to messages or deletes from messages, other members of a work group, organization, friends list, individuals that the user meets in a social context (e.g., based on calendar and meeting entries), and the like. Additional context information can comprise an access device(s) 304D employed to execute interface applications providing network access, and user preferences 304E contained in a user profile. In at least some aspects, the user context information can comprise a user disposition(s) 304F with respect to the network, users of the network or applications associated there with. The disposition(s) 304F can be determined based on content of messages initiated by the user, responses to messages, or time or frequency of responding to messages, or user input pertaining to disposition. The disposition(s) 304F can be a function of a particular type of network, type of interface application or messaging application, a function of user group(s) associated with a user, a function of user location, time of day, or other physical context, or combinations thereof.

In at least some aspects, disposition(s) 304F can be determined from biometric response data obtained from one or more biometric sensors (not depicted) focused on a network user. For instance, a camera coupled with a computer can capture video data of a user interacting with a network interface application, or interacting personally with another individual (e.g., another user of the network). The video data can be sent or streamed to a computing device. A device application can analyze video data of the user, including facial expressions and changes thereof, changes in skin color, identify sweating, nervous activity, pupil size/dilation, and so on, to obtain biometric response data for the user. Infrared sensors can determine body temperatures, to detect changes in body temperature. Audio devices (e.g., microphones) can capture spoken words and sounds emitted by a user while interacting with an interface device (e.g., the computer). Thus, where a user speaks a comment or makes a particular sound, laughs, becomes nervous, begins sweating, becomes relaxed, etc., a use context and disposition can be inferred

In addition to the user context information 304, mediation component 302 can also access interface application templates 306 and social network functionality for modifying composition of a network. The interface templates 306 can be a set of pre-defined or partially pre-defined (e.g., having configurable building block features) application contexts and features associated with such contexts. Application contexts can comprise, for instance, spreadsheet functionality for data management, word processing functionality, messaging functionality, presentation slide functionality, user group tools and user connectivity functionality for modifying user connectivity in a network, or the like or a combination thereof. The interface templates 306 can comprise open-ended programming interfaces, enabling subsets of the contexts or associated functionalities to be selected individually or in combination with one or more other such contexts/functionalities. Further, the open-ended architecture of the templates 306 can facilitate integration with existing application interfaces for a network. Accordingly, mediation component 302 can pull subsets of the templates for integration into one or more such application interfaces, to adapt the networks to user context. Likewise, the social network functions can include sets of features such as group messaging, data and application sharing, message posting, blogging interfaces, directed data dissemination (e.g., for top-down organization direction) or disperse data dissemination (e.g., for group-up or ‘viral’ dissemination of topics spread based on user interests) and other features of social networking applications. Similar to the interface templates 306, the social network functions 308 can comprise an open-ended architecture enabling piecemeal integration into applications and programs employed by a user to access the network.

Mediation component 302 can select subsets of the interface applications 306 or social network functions 308 based on the user context information 304 to obtain features determined to be useful, easily understood, or similar to existing usage patterns, or combinations thereof. The determination can be inferred utilizing machine learning and optimization 310 to more accurately match the user context to a user's actual goals, requirements, and interests, and identify subsets of the interface templates 306 and social network functions suitable for advancing those goals, requirements and interests. Furthermore, the optimization 310 can update the use context over time to accommodate for changes in a user's interaction with a network, based on changes in received user context information 304. In order to infer user context having a highest probability of matching a user's actual use of network applications, machine learning and optimization component 310 can utilize a set of models (e.g., user interface model, user use history models, user biometric response models, use statistics model, etc.) in connection with determining or inferring user predisposition toward network tools and applications, or other users of the network. The models can be based on a plurality of information (e.g., suitable portions 304A-304F of the user context information and templates 306 and social network functions 308, etc.). Optimization routines associated with machine learning and optimization component 310 can harness a model that is trained from previously collected data, a model that is based on a prior model that is updated with new data, via model mixture or data mixing methodology, or simply one that is trained with seed data, and thereafter tuned in real-time by training with actual field data based on parameters modified as a result of error correction instances.

In addition, machine learning and optimization component 310 can employ machine learning and reasoning techniques in connection with making determinations or inferences regarding optimization decisions, such as matching context of users with open-ended application functionality 306, 308 across a plurality of user use contexts. For example, machine learning and optimization component 310 can employ a probabilistic-based or statistical-based approach in connection with identifying and/or updating a baseline user context for a user based on similar data collected for a plurality of users. Inferences can be based in part upon explicit training of classifier(s) (not shown), or implicit training based at least upon one or more monitored results, and the like.

Machine learning and optimization component 310 can also employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various aspects described herein. Methodologies employed by optimization module 310 can also include mechanisms for the capture of logical relationships such as theorem provers or heuristic rule-based expert systems. Inferences derived from such learned or manually constructed models can be employed in other optimization techniques, such as linear and non-linear programming, that seek to maximize probabilities of error. For example, maximizing an overall accuracy of user context data and network tools adapted with subsets of the templates 306 and social network functions 308 can be achieved through such optimization techniques.

Upon selecting a suitable subset of interface templates 306 and social network functions 308 based on user context information 304, mediation component 302 can forward the selected subsets to a network interface device 314 employed by the user. The device 314 can utilize the subsets of templates 306 and functions 308 to adapt an interface application and arrive at a modified interface application 312. In some aspects, the selected subsets can be packaged into an executable application suitable for modifying the interface application (312) to integrate the templates 306 and functions 308, facilitating automatic modification of the interface application. Additionally, the selected data/application can be stored in an interface profile 318 at a profile database 316 for subsequent reference. Furthermore, changes to the selected data/applications, based on changes in user context information 304, can be updated to the interface profile 318 to provide a current profile for a user.

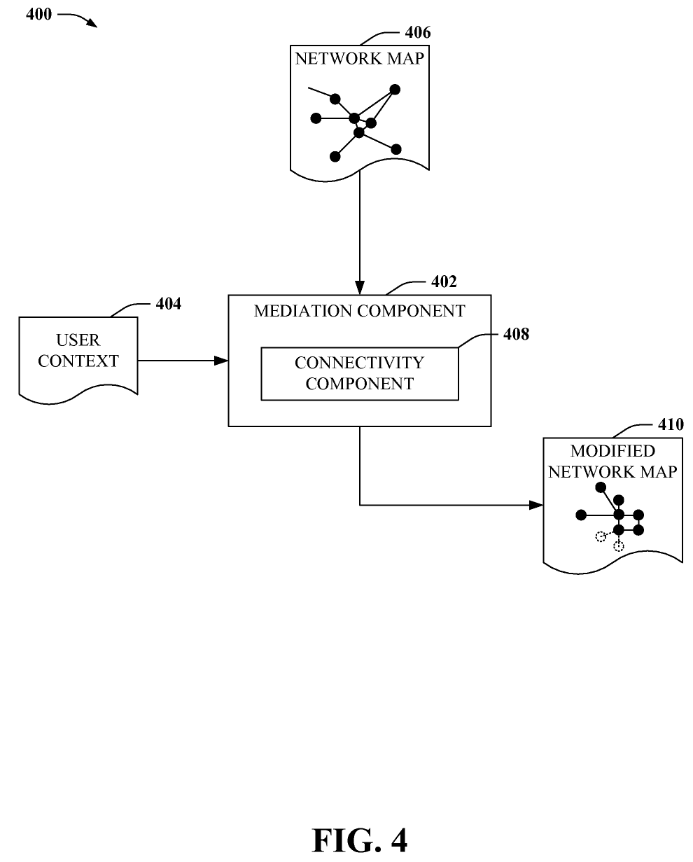

FIG. 4 depicts a block diagram of an example system 400 for providing adaptive network connectivity for users of a network. System 400 can comprise a mediation component 402 that obtains user context data 404 pertinent to the user and one or more other users of the network. The user context data 404 can define interests, tasks, goals, or projects in which the user is involved. Additionally, the user context data 404 can include disposition of the user toward one or more other users, or toward the interests/tasks/goals/projects, to provide further perspective for employing adaptive network in advancing the interests, tasks etc., for the user.

Additionally, the mediation component 402 can obtain a current network connectivity map 406 for the network. The connectivity map can define various users as nodes in the network, and include links between the users. Links can be based on interactions between the users in a social or enterprise context (e.g., friends, friends of friends, client-attorney, supplier-purchaser, and so on). Additionally, the network map 406 can include metadata providing additional background information for users and links. The metadata can specify users' preferred interface applications or communication devices employed for accessing the network, inferred or specified usage history, habits or preferences thereof, or define the nature of the links between the users (e.g., the social or enterprise interaction context). Furthermore, the metadata can include experiences, expertise, and interests of the various users.

A connectivity component 408 can employ the user context 404 and update the composition of the network map 406, or a view or representation thereof, in order to facilitate advancement of user interests, goals, projects, and so on. For instance, in at least one aspect, the composition of the underlying social network representation can remain unchanged, but a task-based view of a subset of the social network can include modified user node arrangements, user links or user contextual data. Updating the composition can be based, for instance, on identifying an interest of the user with an expertise of another user obtained from the network connectivity map 406 metadata. As a particular example, if a user context 404 indicates that a user is currently working on a particular marketing task, the connectivity component 408 can re-arrange the network map 406 to position the user closer to other users having experience or expertise in marketing. If specific information pertaining to the type of marketing task is available, or what market or clients are targeted, users having experience with the market or clients can also be identified, where suitable data exists, to arrange the connectivity map accordingly. Furthermore, arrangement of the connectivity map 406 can be based on disposition of the user with one or more other use nodes of the map 406. Thus, for instance, if user context 404 indicates that a particular user is not liked by the user, connectivity component 408 can situate the respective users a relatively further distance than other, preferred users. In at least one aspect, reasoning employed in arranging one or more nodes or links of the map 404 can be annotated (e.g., via metadata or other suitable data annotation means) to specify the reasoning.

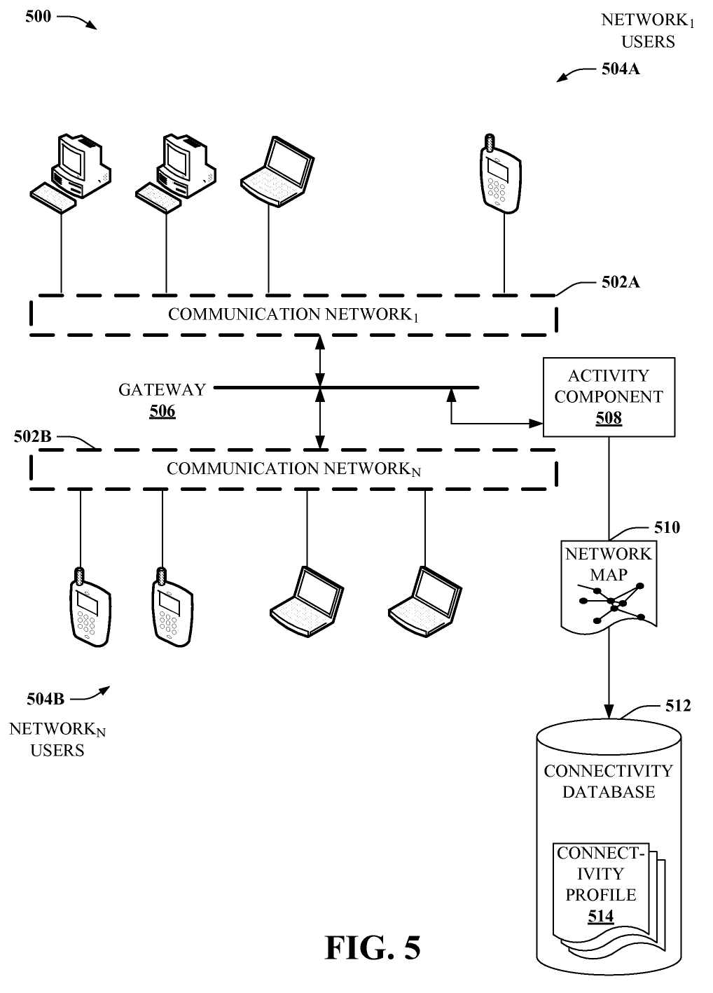

After determining the modified arrangement, connectivity component returns a modified network map 410 to the mediation component 402. Mediation component 402 can then output the modified network map 410 to an interface employed by the user. Further, a notification mechanism, such as an alarm, message, pop-up, or the like can be issued bringing the user's attention to availability of the modified network map 410. It should be appreciated that in some aspects of the subject disclosure, the network map 406 can integrate multiple social networks. Thus, a user's organizational network can be employed, as well as friend networks, public Internet social networks, and networks employed by other users included in such networks (e.g., see FIG. 5, infra). Accordingly, system 400 can search for and obtain network connectivity information across a wide network spectrum, increasing likelihood that useful data, heretofore unknown to the user, can be presented in the modified network map 410.

FIG. 5 depicts a block diagram of an example system 500 for providing adapted user connectivity across multiple user network platforms, according to one or more aspects of the subject disclosure. System 500 comprises a plurality of communication networks 502A, 502B coupled by a network gateway 506. The communication networks 502A, 502B can comprise messaging networks (e.g., IM, SMS), the Internet or portions thereof such as Internet social networks, private corporate networks, or other suitable communication networks (502A, 502B). System 500 further comprises various suitable devices 504A, 504B employed by network users in accessing the respective networks 502A, 502B. Such devices 504A, 504B can include desktop computers, laptop computers, mobile phones, or other suitable processing devices.

In addition to the foregoing, system 500 comprises an activity component 508 that maps interactions between user devices 504A, 504B of the networks 502A, 502B. For instance, activity component 508 can comprise a centralized entity (508) coupled to the network gateway 506 that facilitates data exchange between the respective networks 502A, 502B. In other aspects, the activity component 508 can comprise respective client entities located at the user devices 504A, 504B that can monitor data and message usage at the devices 504A, 504B and provide such information to a server entity (508) coupled with the gateway 506, directly or indirectly (e.g., via another network—not depicted).

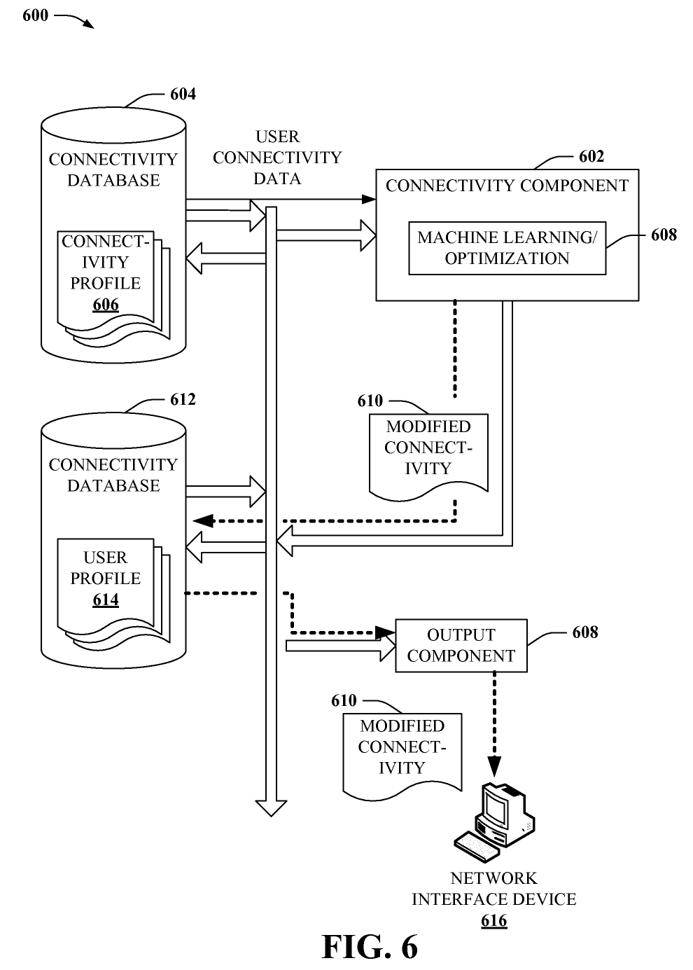

To track user interactions, activity component 508 can monitor messages sent between user devices 504A, 504B, and optionally track users logging in at the respective devices 504A, 504B. Each message from one device/user to another can establish a connection score between such devices/users. In some aspects, messages sent directly to users (e.g., on an e-mail ‘To:’ line) can be scored higher than messages on which a user is copied. By totaling scores, users can be connected based on a hierarchy of scores and inter-related into a network connectivity map 510. The connectivity map 510 can be output by the activity component 508 can stored in a connectivity profile 514 at a connectivity database 512. Changes in user interactions over time can be updated to the profile 514 to ensure current connectivity data. Accordingly, system 500 can provide a suitable mechanism for generating network user connectivity, employed in other aspects of the subject disclosure for implementing adaptive networking (e.g., see FIG. 4, supra, and FIG. 6, infra).

FIG. 6 depicts a block diagram of an example system 600 for disseminating user connectivity information to user devices coupled with a communication network. System 600 comprises a connectivity database 604 that stores connectivity profiles 606, for one or more users of a network, optionally as a function of network employed by a user. Connectivity profiles 606 can be provided to a connectivity component 602 for implementing adaptive networking as described herein. Thus, for instance, the connectivity component 602 can modify a connectivity map based on user context information, to identify other users of the network having experience or expertise in an interest, task, or project of the user. Additionally, connectivity component 602 can employ machine learning and optimization 608 to infer user interests/tasks/experience/expertise based on user context, and accurately match users based on such inferred information.

After determining suitably connected users, connectivity component 602 can generate and output a modified connectivity map 610 linking the connected users as a function of effectiveness in advancing the interests of the users. The modified connectivity map 610 can be stored in a user profile 614 in connectivity database 612. Additionally, an output component 608 can extract the modified connectivity map 610 based and provide the map 610 to a network interface device 616 employed by a user. Providing the modified connectivity map 610 can be triggered based on updating such map to the connectivity database 612, based on a command initiated at the network interface device 616, or can be provided periodically by the output component 608. According to at least some aspects of the subject disclosure, output component 608 can further initiate an alert application (e.g., audio file, pop-up message, e-mail message, etc.) to alert the user of output of the modified connectivity map 610.

The aforementioned systems have been described with respect to interaction between several components. It should be appreciated that such systems and components can include those components or sub-components specified therein, some of the specified components or sub-components, and/or additional components. For example, a system could include network morphing system 102, interface devices 206, communication network 202, data store 218 and usage profile 220, or a different combination of these and other components. Sub-components could also be implemented as components communicatively coupled to other components rather than included within parent components. Additionally, it should be noted that one or more components could be combined into a single component providing aggregate functionality. For instance, activity component 508 can include connectivity component 602, or vice versa, to facilitate generating and modifying a network connectivity map by way of a single component. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

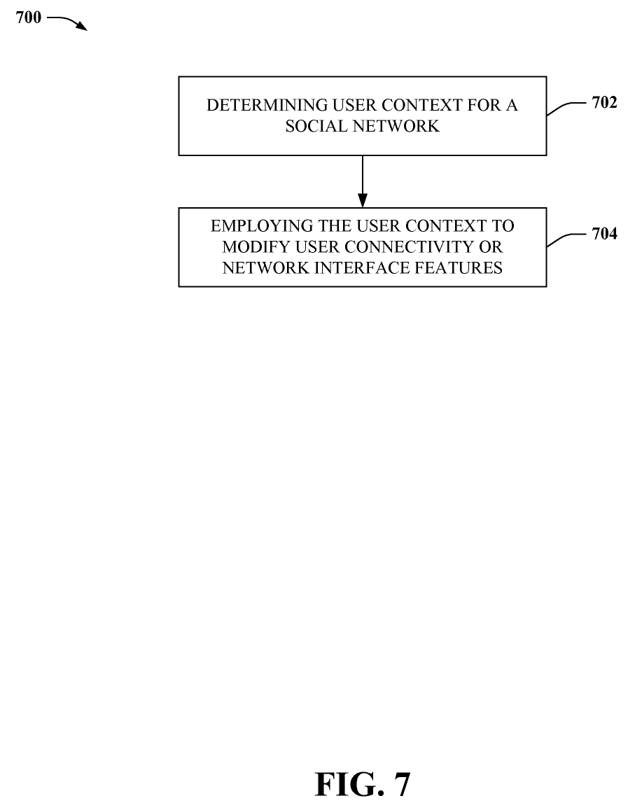

In view of the exemplary systems described supra, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or media.

FIG. 7 depicts a flowchart of an example methodology 700 for providing adaptive networking according to aspects of the subject disclosure. At 702, method 700 can determine user context for a user of an electronic social network. The user context can provide user usage history in interacting with the social network, as well as other information that can be employed in categorizing the user amongst other users, or providing pertinent context for social network preferences or a manner in which the network is utilized to accomplish tasks or interact with other users.

As an example of the foregoing, the user context can identify interface applications employed in accessing the social network or an underlying communication network supporting the social network, and comprise habits, preferences or expertise with respect to the interface applications (e.g., a messaging program for data exchange with the social network, message inbox management, response times, frequency of responses, frequency of message deletion, etc., a web interface to access the social network, number of inter-connected users, frequency of exchanging data, applications or media with such users, quality or context of inter-user links, and so on). In addition the type and degree to which a user employs social network interfaces can be utilized to infer usage habits. For instance, a user that subscribes to RSS feeds, regularly updates a public web profile, updates a blog site, integrates device-applications (e.g., e-mail, IM, word processing) with web-based applications, or the like, can be inferred to be a relatively sophisticated user, as compared with a user that only subscribes to a single social network, employs a standard web interface, and has no user preferences established. Accordingly, in some aspects the user context can include a ranking hierarchy that rates users of the network on a scale associated with a user category (e.g., expertise). It should be appreciated that many categorizations of users based on user activities are contemplated as part of the subject disclosure, though only a finite number of specific examples are articulated herein. Accordingly, the subject disclosure should not be interpreted to include only those articulated aspects; rather, aspects not disclosed that are within the spirit and scope of the subject disclosure and appended claims are incorporated herein.

Further to the above, the user context can provide user disposition toward the social network. User disposition can be determined based on user reactions to device-based stimuli (e.g., receiving an incoming message, sending a message, employing the application in accessing the network, accomplishing tasks via the network, and so on). Thus, for instance, user reactions can comprise a manner in which the user interacts with network-device messaging, as described herein, changes in such interactions (e.g., evidencing an erratic or atypical behavior for the user), or can comprise explicit disposition input from the user, or biometric sensor data of the user when interacting with an interface application, or a combination thereof. Additionally, the context can categorize users as a function of user groups, team members or members of an organization, writing style, message content, amount or degree of interactivity with other users of the network, and so on.

At 704, method 700 can employ the user context to modify composition of a representation of the social network. In some aspects, the composition can comprise user inter-connectivity, or other suitable categories for relating and providing relationship context for users of the social network. In other aspects, the composition can comprise applications, tools and inter-network interfaces employed to communicate on the network. In still other aspects, a combination of the foregoing compositions of the network can be modified to suit the user context.

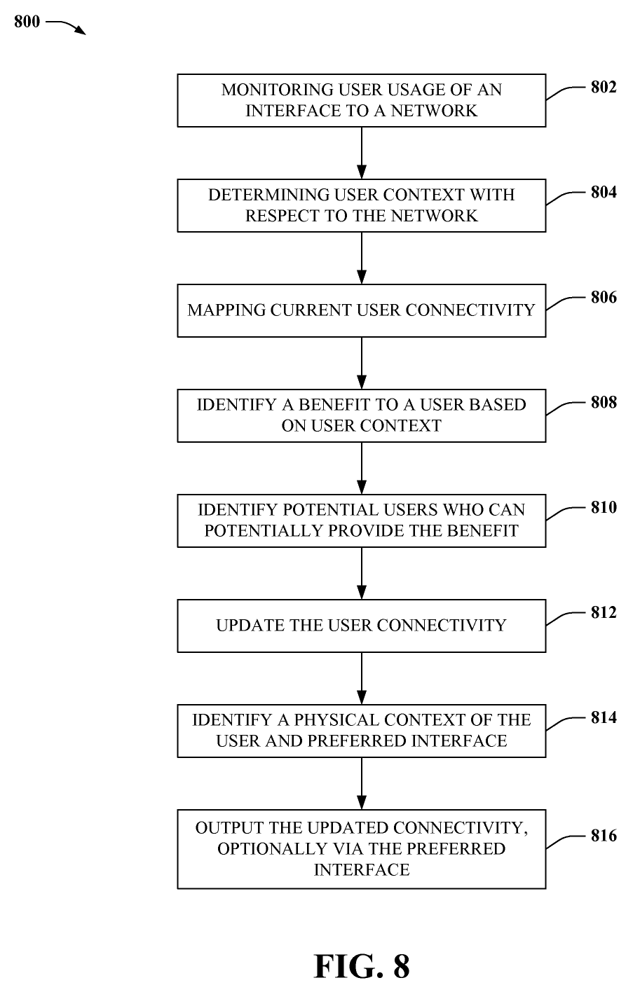

FIG. 8 depicts a flowchart of an example methodology 800 for modifying social network connectivity based on user contextual information according to particular aspects of the subject disclosure. At 802, method 800 can monitor user usage of an interface to a communication network, to identify usage patterns, dispositions, or preferences of the user, or the like. At 804, method 800 can determine user context with respect to the network, as described herein. At 806, method 800 can map current user connectivity for a social network maintained on the communication network. The connectivity map can comprise links to different users based on network interactions with such users, as well as context data describing the users or links between such users.

At 808, method 800 can identify a benefit to a user based on user context. The benefit can be inferred from a task or goal the user is engaged in, from goal or desired result input provided by the user (e.g., determined from the user context or from language processing analysis of data exchanged with other users), or of similar goals of similarly situated users (e.g., determined at least based on degree of relatedness provided by the connectivity map), or a combination thereof or of the like. At 810, method 800 can identifier other potential users that can provide or advance the benefit to the user. At 812, method 800 can update the user connectivity map in accordance with the identified users and an inferred degree of usefulness to the user based on the task or goal and context of the identified user. At 814, method 800 can identify a physical context of the user and preferred interface to the social network. In some aspects, the preferred interface can be a function of the physical context, which can comprise user location, time of day, day of a week, time of year, current weather for the location, whether the user is indoors or outside, in a meeting, having a meal, or in whose company the user is in, and so on. At 816, method 800 can output the updated connectivity to the user, optionally via the preferred interface, in a manner suitable to the user's physical context. As a particular example, if the user is determined to be driving in an automobile, the connectivity can be sent to a mobile device of the user, rather than an office desktop, optionally employing text-to-voice to provide an audio presentation of the connectivity map, changes thereto, or context metadata associated there with.

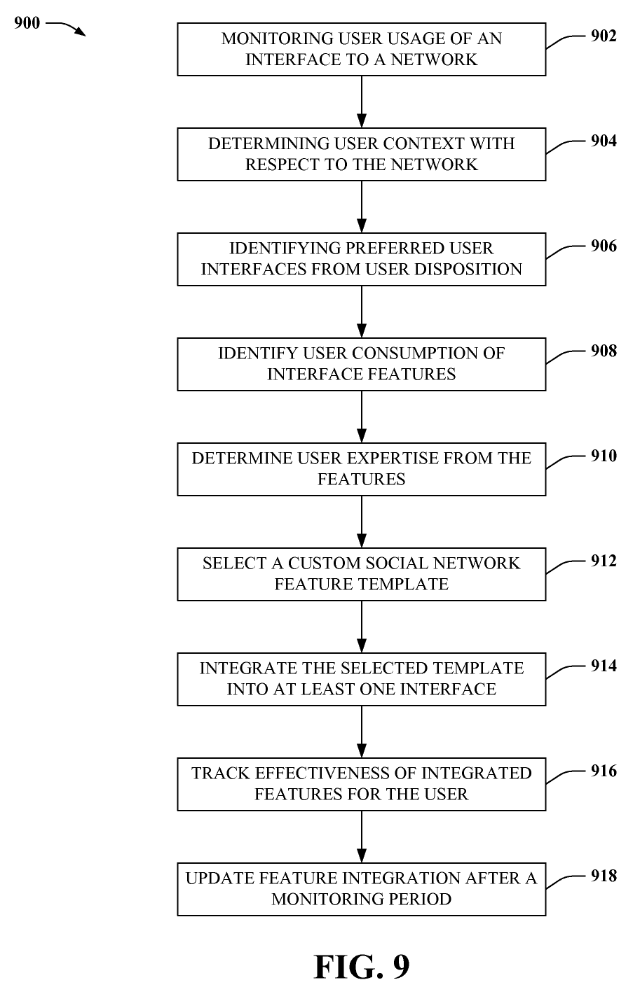

FIG. 9 depicts a flowchart of an example methodology for adapting network interface tools according to determine user networking context. At 902, method 900 can monitor user usage of an interface to a network. At 904, method 900 can determine a user context with respect to the network based on the user usage, user preferences, determined user disposition, or explicit contextual information provided by the user or similarly situated users of the network (e.g., situation determined from a user connectivity map, for instance). AT 906, method 900 can identify preferred user interface applications to the network. In at least some aspects, the preferred user interface applications can be based on usage history or disposition with respect to use of the interface applications. At 908, method 900 can identify consumption of features of an interface application. At 910, method 900 can determine user expertise from the features consumed, and a manner in which a user employs the features. At 912, method 900 can select a custom social network template based on the determined user context, feature consumption or user expertise. At 914, method 900 can integrate the selected custom social network template into at least one interface application. Thus, as one example, the selected template can be integrated into an e-mail program that the user employs in exchanging messages with the network. Additionally, at 916, method 900 can track effectiveness of the feature integration for the user. At 918, method 900 can update feature integration after a monitoring period based on the integration effectiveness and identified changes in the user usage context or disposition toward the modified interface application, as compared with the un-modified application.

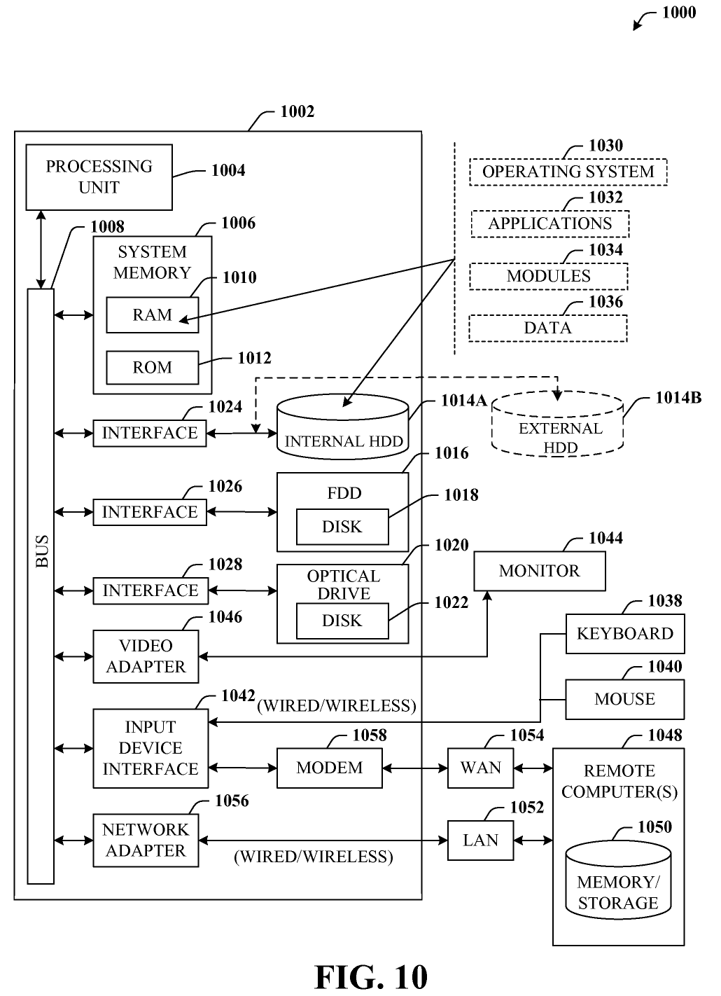

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above can be suitable for application in the general context of computer-executable instructions that can run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Continuing to reference FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014A (e.g., EIDE, SATA), which internal hard disk drive 1014A can also be configured for external use (1014B) in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE802.11 (a, b, g, n, etc.) to provide secure, reliable, fast wireless connectivity. A WiFi network can be used to connect computers to each other, to the Internet, and to wired networks (which use IEEE802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet can include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art can recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as a computer-readable medium having computer-executable instructions for performing the acts and/or events of the various methods.

In addition, while a particular feature may have been disclosed with respect to only one of several implementations, such feature can be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for adapting a network, comprising:
a database for aggregating data descriptive of inter-personal relationships of a set of users of a communication network, the inter-personal relationships forming a social network;
a tracking component that infers a context of a user of a set of electronic devices coupled with the network; and
a mediation component that modifies composition of the social network, or an interface to the communication network, based on the user context.

2. The system of claim 1, the mediation component adds or subtracts user nodes or relationships between user nodes to modify composition of the social network.

3. The system of claim 1, the context comprising a physical context of the user or a usage context of the user relative to a subset of the electronic devices.

4. The system of claim 1, further comprising a usage component that compiles data pertaining to user usage of the set of electronic devices, the tracking component employs the compiled data in inferring the user context.

5. The system of claim 1, the interface to the communication network comprising a communication application or an operating system of a subset of the electronic devices.

6. The system of claim 1, further comprising an output component that formats a subset of the aggregated data, descriptive of the modified social network composition, for user consumption.

7. The system of claim 1, further comprising a context component that tracks user location, usage patterns, message content or user usage preferences to facilitate determination of the context.

8. The system of claim 7, the usage patterns comprise at least one of:
an interface application employed to interact with the social network;
features of the interface application employed by a user;
responses to received messages;
content of a message;
frequencies of particular responses to the received messages;
a device employed to interface to the network; or
a user physical context, or a combination thereof.

9. The system of claim 7, wherein:
the context component determines a user disposition with respect to the interface and records the disposition in a disposition profile; and
the mediation component employs the user disposition for modifying the composition of the social network or the interface to the social network.

10. The system of claim 1, the mediation component incorporates social networking features into the interface based on the inferred context.

11. The system of claim 10, the context is inferred based on at least one of:
a task a user is engaged in;
an expertise of the user or a second user;
content of a message;
a user location;
current utilization of the interface by the user; or
a device currently employed by the user to execute the interface.

12. A method of customizing a social network, comprising:
aggregating data that is descriptive of inter-personal relationships of a set of users of a communication network, the data representing users as nodes and relationships between the users as node connections;
determining a context of a user based on user use of an application or device providing an interface to the communication network; and
modifying composition of the user nodes and node relationships or of features of the interface to match the context of the user.

13. The method of claim 12, further comprising dynamically reconfiguring the user relationships based on a current user context of the user and outputting the reconfigured relationships to the user via the interface.

14. The method of claim 12, further comprising outputting the modified interface features to a control module that updates the interface according to the modified features.

15. The method of claim 12, determining the context further comprises at least one of:
tracking usage patterns pertaining to the interface application;
identifying a current task or interest of the user;
maintaining a knowledge database of user interests or user expertise;
employing language processing to infer meaning from user communication involving the network; or
determining a physical context of the user, or a combination thereof.

16. The method of claim 12, modifying the application features further comprises incorporating communication features of a social network into the interface application.

17. The method of claim 12, modifying user relationships further comprises adding, deleting or modifying user social connectivity based on the user context.

18. The method of claim 12, the user interface application comprises at least one of:
an e-mail application;
a network messaging application;
a message board application;
a public social network interface;
a private enterprise social network interface; or
a mobility application.

19. The method of claim 12, further comprising obtaining explicit user contextual input in conjunction with determining the user context.

20. A system for providing customized social networking, comprising:
a mining algorithm that monitors user usage of interface applications to a communication network that comprises a social network;
an inference component that determines user disposition toward the social network;
a tracking component that determines a user context for the network from the user usage and a current user disposition;
a database that maintains a context profile for a user of the network; and
a mediation component that modifies user connectivity pertaining to the social network or features of an interface application based on the context profile.
